(19) United States
(12) Patent Application Publication
(10) Pub. No.: US 2023/0360077 A1
(43) Pub. Date: Nov. 9, 2023

(54) SYSTEM FOR INTERACTIVE ADVERTISEMENT

(71) Applicant: Hun Jae LEE, Yorba Linda, CA (US)

(72) Inventor: Hun Jae LEE, Yorba Linda, CA (US)

(21) Appl. No.: 17/737,819

(22) Filed: May 5, 2022

(51) Int. Cl. G06Q 30/02

(52) U.S. Cl. CPC G06Q 30/0218; G06Q 30/0258

(57) ABSTRACT

A system to provide an interactive advertisement to a user includes an advertisement server, a user device, and an advertisement application software installed on the user device. The advertisement server includes a database which stores a plurality of questions concerning an advertiser or the advertiser's goods, each question having an answer hint. The advertisement server includes a question selection module, an advertisement assessment module, and a user selection module. The advertisement application software is configured to: receive a commercial of the advertiser; receive a combination of questions from the advertisement server, and display the combination of questions; and receive answers from the user, and send the answers to the advertisement server. The user is allowed to change the answers, and a reward is given to the user if the number of correct answers exceeds a predetermined number.

### FIELD OF THE INVENTION

The present invention relates to a system for an interactive advertisement. More particularly, the invention relates to a system for an interactive advertisement which includes a plurality of advertisers and a plurality of users. Through the system, users are asked questions on an advertiser and the advertiser's goods to win a reward. While answering the questions, users can have access to answer hints which are made of numerous contents on the advertiser, and the advertiser's goods or services.

### BACKGROUND OF THE INVENTION

An advertisement is a means of communication to promote or sell a product or service of an advertiser. An advertiser pays for an advertisement, which is communicated to users through mass media such as television, radio, newspaper, the Internet, social media, websites, etc. The advertisement can be made of text, image, audio, or video in order to attract interest, engagement, and sales of the advertiser's goods or services and boost brand recognition.

An advertisement distributed through mass media is generally a one way communication to an audience, which passively experiences the advertisement. In order to supplement this downside, interactive advertisements have been introduced to engage with consumers directly. An interactive advertisement is a great way to get consumers to engage with a brand in order to create a stronger interest and connection with the advertiser's brands, goods, or services.

However, the degree of a consumer's engagement with an advertiser's brand is still limited in an interactive advertisement. For example, certain online games allow users to look into preview of the applications and try the games before downloading the applications, and certain video advertisements allow the view to change the color or feature of the advertised products. These user experiences are still limited.

Therefore, to solve the above problems, a system for an interactive advertisement which provides numerous contents on an advertiser's brands, goods, or services and engages consumers to learn about the advertiser and advertiser's brands, goods, or services in order to win rewards are provided, as there is a need for a system that accomplishes these goals. This invention is directed to solve these problems and satisfy the long-felt need.

### SUMMARY OF THE INVENTION

The present invention contrives to solve the disadvantages of the prior art. The present invention provides a system for an interactive advertisement which includes a plurality of advertisers and a plurality of users wherein users are asked questions on an advertiser and the advertiser's goods to win a reward. While answering the questions, users can have access to answer hints which are made of numerous contents on the advertiser, and the advertiser's goods or services.

The object of the invention is to provide a system to provide an interactive advertisement to a user, which includes an advertisement server, a user device, and an advertisement application software installed on the user device. The advertisement server includes a processor and a database, and the database includes a plurality of questions concerning an advertiser or the advertiser's goods. Each question has an answer hint. The user device has a display and an input means, and the advertisement application software is associated with a user account.

The advertisement server includes a question selection module, an advertisement assessment module, and a user selection module. The user selection module selects users to receive questions for winning the reward, and the question selection module selects a combination of questions from the plurality of questions to be presented to the user. Furthermore, the advertisement assessment module receives an advertisement goal from the advertiser and analyzes the performance of the interactive advertisement.

The advertisement application software is configured to: receive a commercial of the advertiser from the advertisement server and play the commercial on the display; receive the combination of questions from the advertisement server, and display the combination of questions; and receive answers to the combination of questions from the user through the input means, and send the answers to the advertisement server. The commercial is related to either the advertiser or the advertiser's goods. The questions are presented to the user one by one or together, and each question includes an answer hint which is configured to be displayed upon the user's request. In addition, the advertisement application software is configured to permit the user to change the answers to questions if the answers are not correct. The advertisement server is configured to send a reward to the user account if the number of correct answers exceeds a predetermined number.

Another object of the invention is to provide a system for providing an interactive advertisement to a user, which includes an advertisement server, a user device, and an advertisement application software installed on the user device. The database includes a plurality of questions concerning an advertiser or the advertiser's goods, and the advertisement application software is configured to receive the plurality of questions from the advertisement server and present them to the user on the display.

The plurality of questions includes questions on a company history of the advertiser, founder/owner/officers of the advertiser, a corporate identity of the advertiser, a feature of the advertiser's goods, or an advantage of the advertiser's goods. The answer hint may be provided from a variety of contents, including a press release relating to the advertiser or the advertiser's goods, a commercial, contents from a third party contents provider, or the advertiser's website. In addition, when the advertisement application software permits the user to change the answers to questions if the answers are not correct, the advertisement application software may informs the user of either how many answers are not correct or the questions for which the answers are not correct.

Still another object of the invention is to provide a system for providing an interactive advertisement to a user, which includes an advertisement server, a virtual environment server, a user device, an advertisement application software installed on the user device, and a wearable device of the user. The virtual environment server is configured to provide a virtual reality space assigned to a plurality of advertisers, and the wearable device is configured to connect to the virtual environment server to explore the virtual reality space. The virtual reality space further includes a plurality of virtual reality sub-spaces respectively assigned to advertisers. The questions may be presented to the user through the user device or the virtual reality space.

The advantages of the present invention are: (1) the present invention provides an interactive advertisement which allows users to actively experience a number of contents on an advertiser and the advertiser's goods or services; (2) the present invention incentivizes the users to learn about an advertiser and the advertiser's goods or services; (3) the present invention provides an advertisement assessment module to analyze the performance of the interactive advertisement of the present invention in order to find out ways to improve the performance and achieve the advertisement goals; (4) the advertisement assessment module of the present invention allows the advertisers to understand the current state of consumer awareness on the advertisers or their goods or services; (5) the present invention enables collection of reliable user information for analysis; (6) the present invention allows the rewards to be effectively and efficiently used by providing a market place for transactions of the rewards among advertisers; (7) the interactive advertisement of the present invention is connected to a virtual environment server to experience an interactive advertisement on a virtual reality space assigned to a plurality of advertisers; and (8) users can have a more hands-on experience with the advertisers or their goods or services in the virtual reality space.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a schematic diagram of an interactive advertisement according to the present invention;

FIG. 2 shows a schematic view of a user device displaying a question, an answer hint, and an input means according to the present invention;

FIG. 3 shows a flow chart for providing an interactive advertisement according to the present invention;

FIG. 4 shows another schematic diagram of the interactive advertisement interacting with a virtual reality server according to the present invention; and

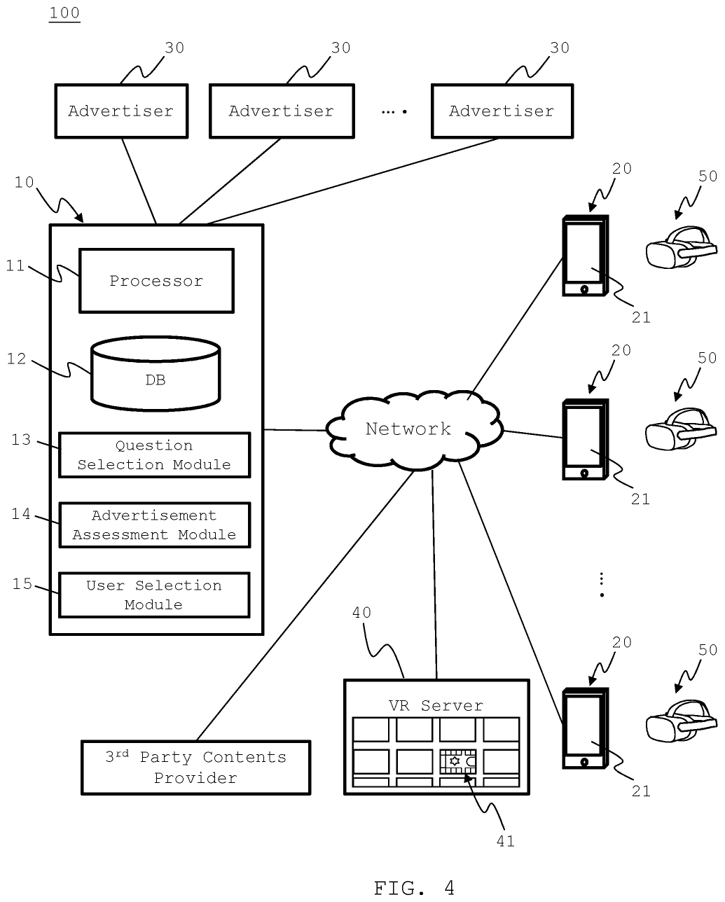

FIG. 5 shows a schematic diagram showing a virtual reality space assigned to advertisers according to the present invention.

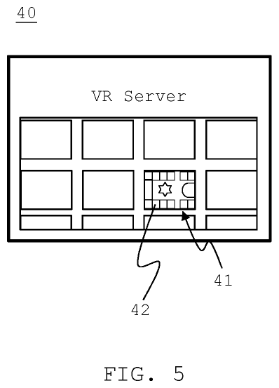

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

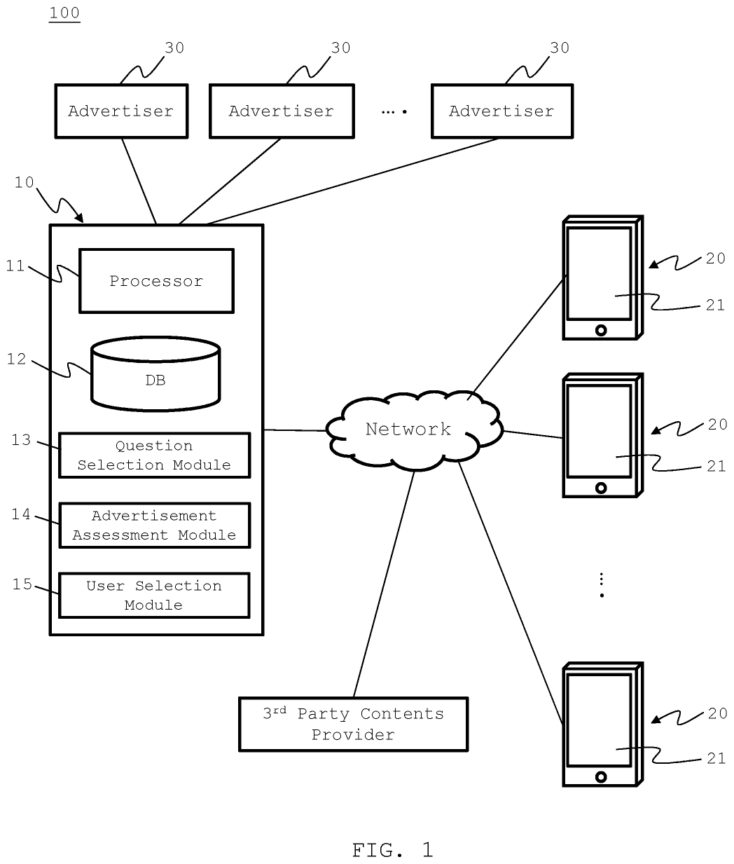

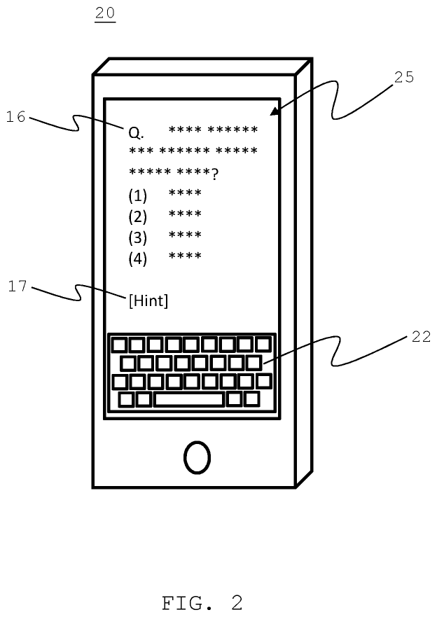

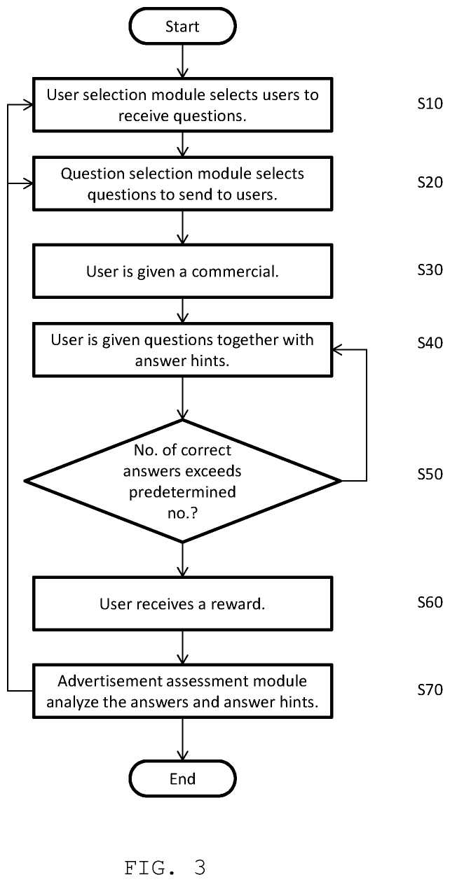

FIG. 1 shows a schematic diagram of an interactive advertisement according to the present invention, and FIG. 2 shows a schematic view of a user device 20 displaying a question 16, an answer hint 17, and an input means 12 on a display 11 according to the present invention. In addition, FIG. 3 shows the steps for providing an interactive advertisement.

As in FIG. 1, the system 100 of the present invention provides an interactive advertisement to a user, and includes an advertisement server 10, a user device 20, and an advertisement application software 25 installed on the user device 20. The advertisement server 10 includes a processor 11 and a database 12, and the database 12 includes a plurality of questions 16 concerning an advertiser 30 or the advertiser's goods. Here, goods include not just products, but also services. Each question has an answer hint 17. The user device 20 has a display 21 and an input means 22, and the advertisement application software 25 is associated with a user account.

The advertisement server 10 includes a question selection module 13, an advertisement assessment module 14, and a user selection module 15. The user selection module 15 selects users to receive questions 14 for winning the reward, and the question selection module 13 selects a combination of questions 16 from the plurality of questions 16 to be presented to the user. Furthermore, the advertisement assessment module 14 receives an advertisement goal from the advertiser 30 and analyzes the performance of the interactive advertisement.

The advertisement application software 25 is configured to: receive a commercial of the advertiser 30 from the advertisement server 10 and play the commercial on the display 21; receive the combination of questions 16 from the advertisement server 10, and display the combination of questions 16; and receive answers to the combination of questions 16 from the user through the input means 22, and send the answers to the advertisement server 10. The commercial is related to either the advertiser 30 or the advertiser's goods. The questions 16 are presented to the user one by one or together, and each question 16 includes an answer hint 17 which is configured to be displayed upon the user's request. Preferably, the questions 16 are multiple choice questions. In addition, the advertisement application software 25 is configured to permit the user to change the answers to questions 16 if the answers are not correct. The advertisement server 10 is configured to send a reward to the user account if the number of correct answers exceeds a predetermined number. If the number of correct answers equals or is smaller than the predetermined number, the user is permitted to change the answers and motivated to explore and study the answer hints to find the correct answers. The user may be simply notified that he failed to win the reward, or notified with the number of incorrect answers and allowed to go back to each question to change the answers, or notified with the questions with incorrect answers so that the user can only change the incorrect answers. If the answers are not correct, the advertisement application software 25 may permit the user multiple times to change the answers to questions. The purpose of the system 100 is to provide the user an opportunity to spend sufficient amount of time and learn about the advertiser 30 and its goods. By exploring numerous contents, the user may be engaged in certain contents and spend more time in them, not just to find correct answers.

The user device 20 may be a mobile phone, a smart phone, a tablet computing device, a desktop computer, a laptop computer, a smart TV, or the like, and the input means 22 may be a touch screen, a touch pad, a keyboard, a mouse, a voice recognition tool, a remote controller, or the like. Furthermore, each question 16 has an answer hint 17 which is made of contents on the advertiser 30 or advertiser's goods such as commercials, press releases, advertiser's own websites, contents stored in third party contents providers, etc. Such contents may be text-based, audio-based, video-based, etc.

The plurality of questions 16 includes questions on a company history of the advertiser 30, founder/owner/officers of the advertiser, a corporate identity of the advertiser 30, a feature of the advertiser's good, or an advantage of the advertiser's good, and the answer hints 17 provide numerous contents to help users find correct answers to questions on such topics. The answer hint 17 includes a press release relating to the advertiser or the advertiser's good, the commercial, a content from a third party contents provider, or the advertiser's website.

The user account may include user information which includes a date of birth, sex, residence, race/ethnicity, etc. The user information may further include income level, profession, education level, nationality, interest, etc. Here, sex includes various sexual orientations. In addition, the advertisement server 10 requires the user to input missing user information before sending the reward to the user account.

The advertisement server 10 further includes a user selection module 15, which selects users to receive the questions 16 for winning the reward. By analyzing the advertisement goal inputted by the advertiser, the user selection module 15 selects relevant parameters and ranges of the parameters from the database of the user information. The users are randomly selected from the chosen parameters and ranges, but the user selection module 15 assigns the numbers of users to be selected from each group of chosen parameters and ranges by analyzing the advertisement goals. When the users have to be selected again to receive the questions for winning the reward, the user selection module 15 may analyze not just the advertisement goals, but also input from the advertisement assessment module 14.

The advertisement assessment module 14 of the advertisement server 10 includes an advertisement goal inputted by the advertiser 30. The advertisement goal may include increased consumer awareness on certain aspects about the advertiser 30 or its goods, and include a parameter whether the advertisement goal relates to the advertiser or the advertiser's good. Further, the goal may further include targeted audience group.

The advertisement assessment module 14 of the advertisement server 10 analyzes the answers from a plurality of users before the users change the answers to win the reward, the answers from the plurality of users after the users change them, and answer hints 17 which the plurality of users requested and explored. Such collected answers and answer hints are analyzed in connection with the user information of the plurality of users. The advertisement assessment module 14 provides the analysis result on the consumer awareness before and after the interactive advertisement of the present invention, and compares such consumer awareness to the advertisement goals.

The users may be selected by the user selection module 15 and given questions on multiple time frames. In this case, the advertisement assessment module 14 of the advertisement server 10 is configured to analyze in time series. The advertisement assessment module 14 may provide input to the user selection module 15 or to the question selection module 13 to reach the advertisement goals. In response to such inputs, the user selection module 15 may adjust the chosen parameters and ranges, and the question selection module 13 may change the combination of questions 16. If a certain target audience group lacks awareness on the advertiser 30 or its goods than any other groups, more users from that target audience group may be selected by the user selection module 15. If users lack awareness on certain aspect of the advertiser 30 or its goods, questions on that aspect may be given to users more than other questions.

When the advertisement application software 25 permits the user to change the answers to questions 16 if the answers are not correct, the advertisement application software 25 may inform the user of either the user's failure to win the reward, or how many answers are not correct, or the questions for which the answers are not correct. If questions with incorrect answers are given, the user can quickly review and change the answers to win the reward. In contrast, if only the user's failure to win the reward or number of incorrect answers are notified, the user has to spend more time to review all the questions to win the reward. The user may spend more time or give up. If giving up rate goes up, the advertisement server 10 may instruct the advertisement application software 25 to change to notification of questions with incorrect answers. In addition, if there is still incorrect answer(s) even after the user won the reward, the advertisement application software 25 displays the correct answer(s) along with the reward.

The advertisement server 10 includes a user selection module 15, which selects users to receive the questions 14 for winning the reward, and the advertisement application software 25 is configured to send a push notification to the user device 20 of the user who was selected by the user selection module 15. Preferably, the push notification includes the reward and how to win the reward.

FIG. 3 shows a flow chart for providing an interactive advertisement according to the present invention. In the step of S10, the user selection module 15 selects users to receive questions 16, and in S20, the question selection module 13 selects questions to send to the users which were selected by the user selection module 15. The users may or may not receive same combination of questions 16. In S30, each user is given a commercial to watch, and in S40, each user is given questions 16 together with answer hints 17 to solve to win a reward. In S50, if the number of correct answers exceeds a predetermined number, the user will receive a reward in S60 whereas if not, the user will be permitted to change the answers in S40. In S70, the advertisement assessment module 14 analyzes the answers submitted by the users and the answer hints which the users explored. The advertisement assessment module 14 evaluates the performance of the interactive advertisement in comparison to the advertisement goals. In addition, the advertisement assessment module 14 provides feedback to the user selection module 15 and the question selection module 13.

In alternative embodiment, the system 100 of the present invention for providing an interactive advertisement to a user includes an advertisement server 10, a user device 20, and an advertisement application software 25 installed on the user device 20. The database 12 includes a plurality of questions 16 concerning an advertiser 30 or the advertiser's goods, and each question 16 has an answer hint 17. The advertisement application software 25 is configured to receive the plurality of questions 16 from the advertisement server 10 and present them to the user on the display 21. The plurality of questions 16 includes questions 16 on a company history of the advertiser 30, founder/owner/officers of the advertiser 30, a corporate identity of the advertiser 30, a feature of the advertiser's good, or an advantage of the advertiser's good, and the answer hint 17 may be from a variety of contents, including a press release relating to the advertiser 30 or the advertiser's good, the commercial, a content from a third party contents provider, or the advertiser's website. When the advertisement application software 25 permits the user to change the answers to questions 16 if the answers are not correct, the advertisement application software 25 informs the user of either how many answers are not correct or the questions for which the answers are not correct.

The advertisement server 10 has a processor 11 and a database 12, and the user device 20 has a display 21 and an input means 22. The advertisement application software 25 installed on the user device 20, and the advertisement application software 25 is configured to: receive the plurality of questions 16 from the advertisement server 10, and display the plurality of questions 16, wherein each question 16 includes an answer hint 17 which is configured to be displayed upon the user's request; receive answers to the plurality of questions 16 from the user through the input means 22, and send the answers to the advertisement server 10; and permit the user to change the answers to questions 16 if the answers are not correct. In addition, the advertisement server 10 is configured to send a reward to the user if the number of correct answers exceeds a predetermined number. The advertisement application software 25 is further configured to send a push notification to the user device 20 of the user who was selected by the user selection module 15. Preferably, the push notification includes the reward and how to win the reward.

In still alternative embodiment, the system 100 of the present invention for providing an interactive advertisement to a user, includes an advertisement server 10, a virtual environment server 40, a user device 20, an advertisement application software 25 installed on the user device 20, and a wearable device 50 of the user. The virtual environment server 40 is configured to provide a virtual reality space 41 assigned to a plurality of advertisers 30, and the wearable device 50 is configured to connect to the virtual environment server 40 to explore the virtual reality space 41. The virtual reality space 41 further includes a plurality of virtual reality sub-spaces 42 respectively assigned to advertisers 30. The questions 16 may be presented to the user through the user device 20 or the virtual reality space 41.

The advertisement server 10 has a processor 11 and a database 12, and the database 12 includes a plurality of questions 16 concerning an advertiser 30 or the advertiser's good, each question 16 having an answer hint 17. The user device 20 has a display 21 and an input means 22, and the advertisement application software 25 is installed on the user device 20 and associated with a user account.

The virtual environment server 40 is configured to provide a virtual reality space 41 assigned to a plurality of advertisers 30, and the wearable device 50 of the user is configured to connect to the virtual environment server 40 to explore the virtual reality space 41 assigned to the plurality of advertisers 30. In addition, the virtual environment server 40 is configured to link the virtual reality space 41 assigned to the plurality of advertisers 30 to the user account.

The advertisement server 10 includes a question selection module 13 and an advertisement assessment module 14. The virtual reality space 41 assigned to the plurality of advertisers 30 is configured to: receive a commercial of the advertiser 30 from the advertisement server 10 and play the commercial where the commercial relates to the advertiser 30 or the advertiser's good; receive a combination of questions 16 selected from the plurality of questions 16 by the question selection module 13 of the advertisement server 10, and display the combination of questions 16, where each question 16 includes an answer hint 17 which is configured to be displayed upon the user's request; receive answers to the combination of questions 16 from the user, and send the answers to the advertisement server 10; and permit the user to change the answers to questions 16 if the answers are not correct. Furthermore, the advertisement server 10 is configured to send a reward to the user account if the number of correct answers exceeds a predetermined number.

The virtual reality server 40 may be operated by the operator of the system 100, or provided by a third party where the virtual reality space 41 assigned to the plurality of advertisers 30 is built on the virtual reality server 40 to be interacted with the advertisement server 10. The virtual reality space 41 assigned to the plurality of advertisers may include the plurality of virtual reality sub-spaces 42 respectively assigned to the plurality of advertisers 30. The virtual reality space 41 may include a map of the space and a center space where the users can obtain information about the space 41 and the plurality of virtual reality sub-spaces 42.

The advertisement server 10 may further include a user selection module 15 which selects users to receive the questions 16 for winning the reward. The virtual reality space 41 assigned to the plurality of advertisers 30 is configured to send a push notification to the user who was selected by the user selection module 15, and the push notification includes the reward and a direction to the virtual reality sub-space 42 associated with the reward.

The plurality of questions 16 includes questions 16 on a company history of the advertiser 30, founder/owner/officers of the advertiser 30, a corporate identity of the advertiser, a feature of the advertiser's good, or an advantage of the advertiser's good, and the answer hint 17 includes a press release relating to the advertiser or the advertiser's good, the commercial, a content from a third party contents provider, or the advertiser's website. In addition, when the advertisement application software 25 permits the user to change the answers to questions if the answers are not correct, the advertisement application software 25 informs the user of either the user's failure to win the reward, how many answers are not correct, or the questions for which the answers are not correct.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A system for providing an interactive advertisement to a user, comprising;
an advertisement server having a processor and a database, wherein the database includes a plurality of questions concerning an advertiser or the advertiser's good, each question having an answer hint;
a user device having a display and an input means; and
an advertisement application software installed on the user device wherein the advertisement application software is associated with a user account,
wherein the advertisement server includes a question selection module and an advertisement assessment module,
wherein the advertisement application software is configured to:
receive a commercial of the advertiser from the advertisement server and play the commercial wherein the commercial relates to the advertiser or the advertiser's good;
receive a combination of questions selected from the plurality of questions by the question selection module of the advertisement server, and display the combination of questions, wherein each question includes an answer hint which is configured to be displayed upon the user's request;
receive answers to the combination of questions from the user through the input means, and send the answers to the advertisement server; and
permit the user to change the answers to questions if the answers are not correct,
wherein the advertisement server is configured to:
send a reward to the user account if the number of correct answers exceeds a predetermined number.

2. The system of claim 1, wherein the plurality of questions includes questions on a company history of the advertiser, founder/owner/officers of the advertiser, a corporate identity of the advertiser, a feature of the advertiser's good, or an advantage of the advertiser's good.

3. The system of claim 2, wherein the answer hint is a press release relating to the advertiser or the advertiser's good, the commercial, a content from a third party contents provider, or the advertiser's website.

4. The system of claim 2, wherein the advertisement application software permits the user multiple times to change the answers to questions if the answers are not correct.

5. The system of claim 1, wherein the user account includes user information which includes a date of birth, sex, residence, and race/ethnicity, and wherein the advertisement server includes a user selection module which selects users to receive the questions for winning the reward.

6. The system of claim 5, wherein the advertisement server requires the user to input missing user information before sending the reward to the user account.

7. The system of claim 1, wherein the advertisement assessment module of the advertisement server includes an advertisement goal inputted by the advertiser, wherein the advertisement goal includes a parameter whether the advertisement goal relates to the advertiser or the advertiser's good.

8. The system of claim 7, wherein the advertisement assessment module of the advertisement server analyzes the answers from a plurality of users before changing them, the answers from the plurality of users after changing them, and answer hints which the plurality of users requested, in connection with the user information of the plurality of users.

9. The system of claim 8, wherein the advertisement assessment module of the advertisement server is configured to analyze in time series.

10. The system of claim 1, wherein when the advertisement application software permits the user to change the answers to questions if the answers are not correct, the advertisement application software informs the user of either the user's failure to win the reward, or how many answers are not correct, or the questions for which the answers are not correct.

11. The system of claim 1, wherein the advertisement server includes a user selection module which selects users to receive the questions for winning the reward,
wherein the advertisement application software is configured to send a push notification to the user device of the user who was selected by the user selection module,
wherein the push notification includes the reward.

12. A system for providing an interactive advertisement to a user, comprising;
an advertisement server having a processor and a database, wherein the database includes a plurality of questions concerning an advertiser or the advertiser's good, each question having an answer hint;
a user device having a display and an input means; and
an advertisement application software installed on the user device,
wherein the advertisement application software is configured to:
receive the plurality of questions from the advertisement server, and display the plurality of questions, wherein each question includes an answer hint which is configured to be displayed upon the user's request;
receive answers to the plurality of questions from the user through the input means, and send the answers to the advertisement server; and
permit the user to change the answers to questions if the answers are not correct,
wherein the advertisement server is configured to:
send a reward to the user if the number of correct answers exceeds a predetermined number.

13. The system of claim 12, wherein the plurality of questions includes questions on a company history of the advertiser, founder/owner/officers of the advertiser, a corporate identity of the advertiser, a feature of the advertiser's good, or an advantage of the advertiser's good,
wherein the answer hint is a press release relating to the advertiser or the advertiser's good, the commercial, a content from a third party contents provider, or the advertiser's website.

14. The system of claim 12, wherein when the advertisement application software permits the user to change the answers to questions if the answers are not correct, the advertisement application software informs the user of either how many answers are not correct or the questions for which the answers are not correct.

15. The system of claim 12, wherein the advertisement application software is configured to send a push notification to the user device, wherein the push notification includes the reward.

16. A system for providing an interactive advertisement to a user, comprising;
an advertisement server having a processor and a database, wherein the database includes a plurality of questions concerning an advertiser or the advertiser's good, each question having an answer hint;
a virtual environment server configured to provide a virtual reality space assigned to a plurality of advertisers;
a user device having a display and an input means;
an advertisement application software installed on the user device wherein the advertisement application software is associated with a user account; and
a wearable device of the user configured to connect to the virtual environment server to explore the virtual reality space assigned to the plurality of advertisers, wherein the virtual environment server is configured to link the virtual reality space assigned to the plurality of advertisers to the user account,
wherein the advertisement server includes a question selection module and an advertisement assessment module,
wherein the virtual reality space assigned to the plurality of advertisers is configured to:
receive a commercial of the advertiser from the advertisement server and play the commercial wherein the commercial relates to the advertiser or the advertiser's good;
receive a combination of questions selected from the plurality of questions by the question selection module of the advertisement server, and display the combination of questions, wherein each question includes an answer hint which is configured to be displayed upon the user's request;
receive answers to the combination of questions from the user, and send the answers to the advertisement server; and
permit the user to change the answers to questions if the answers are not correct,
wherein the advertisement server is configured to:
send a reward to the user account if the number of correct answers exceeds a predetermined number.

17. The system of claim 16, wherein the virtual reality space assigned to the plurality of advertisers comprises the plurality of virtual reality sub-spaces respectively assigned to the plurality of advertisers.

18. The system of claim 17, wherein the advertisement server includes a user selection module which selects users to receive the questions for winning the reward,
wherein the virtual reality space assigned to the plurality of advertisers is configured to send a push notification to the user who was selected by the user selection module,
wherein the push notification includes the reward and a direction to the virtual reality sub-space associated with the reward.

19. The system of claim 16, wherein the plurality of questions includes questions on a company history of the advertiser, founder/owner/officers of the advertiser, a corporate identity of the advertiser, a feature of the advertiser's good, or an advantage of the advertiser's good,
wherein the answer hint is a press release relating to the advertiser or the advertiser's good, the commercial, a content from a third party contents provider, or the advertiser's website.

20. The system of claim 16, wherein when the advertisement application software permits the user to change the answers to questions if the answers are not correct, the advertisement application software informs the user of either the user's failure to win the reward, how many answers are not correct, or the questions for which the answers are not correct.
